(19) United States
(12) Patent Application Publication
(10) Pub. No.: US 2005/0289253 A1
(43) Pub. Date: Dec. 29, 2005

(54) Apparatus and method for a multi-function direct memory access core

(76) Inventors: Samantha J. Edirisooriya, Tempe, AZ (US); Joseph Murray, Scottsdale, AZ (US); Gregory W. Tse, Tempe, AZ (US); Vishram A. Sarurkar, Bangalore (IN); Manish K. Goel, Bangalore (IN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/877,587

(22) Filed: Jun. 24, 2004

(51) Int. Cl. G06F 13/28

(52) U.S. Cl. 710/22

(57) ABSTRACT

A method and apparatus for a multi-function direct memory access core are described. In one embodiment, the method includes the reading of a direct memory access (DMA) descriptor having associated DMA data to identify at least one micro-command. Once the micro-command is identified, the DMA data is processed according to the micro-command during DMA transfer of the data. In one embodiment, a DMA engine performs an operation on the DMA data in transit within the DMA controller according to the identified micro-command. Hence, by defining a primitive set of micro-commands, the DMA engine within, for example, an input/output (I/O) controller hub (ICH), can be used to perform a large number of complex operations on data when data is passing through the ICH without introducing latency into the DMA transfer. Other embodiments are described and claimed.

### FIELD OF THE INVENTION

One or more embodiments of the invention relate generally to the field of integrated circuit and computer system design. More particularly, one or more of the embodiments of the invention relate to a method and apparatus for a multi-function direct memory access core.

### BACKGROUND OF THE INVENTION

Data transfer between a peripheral device, such as an input/output (I/O) device, and system memory may be accomplished using programmed I/O transfers or direct memory access (DMA). Generally, programmed I/O transfers provide a less efficient method than DMA. For programmed I/O transfers, an I/O device generates an interrupt to inform a central processing unit (CPU) that the I/O device requires data transfer. Issuing of the interrupt causes the CPU to write data from the I/O device to system memory or read data from system memory and provide the data to the I/O device.

Generally, programmed I/O transfers are less efficient than DMA since they require the generation of at least two bus cycles by the CPU for each data transfer. In addition, programmed I/O transfers occupy the CPU to transfer the data, rather than performing its primary function of executing application code. Conversely, DMA provides a more efficient method to accomplish transfer between an I/O device and system memory. To perform DMA, the I/O device requires designation as a bus master. A bus master I/O device may initiate a bus cycle to communicate with memory once the I/O device is awarded bus ownership via bus arbitration.

Generally, such I/O devices are not directly coupled to memory, but are coupled to a controller, such as, for example, an I/O controller hub, which performs the read/write to/from memory as directed by the I/O device. This bus master or DMA method of data transport is more efficient because the CPU is not involved in the data transfer and typically a single burst cycle is generated to move a block of data. To direct the controller to perform DMA, the I/O device may populate the fields of a DMA descriptor.

In operation, the DMA descriptor is read by the controller, which either reads or writes requested data to or from memory, referred to herein as “DMA data.” A controller optimized to perform block transfers of data between an I/O device bus and local processor memory is referred to herein as a “DMA controller.” In addition, some DMA controllers support descriptor chaining. Generally, DMA descriptors that describe one DMA transfer each can be linked together in, for example, I/O local memory to form a linked list. Each chain descriptor contains all the necessary information for transferring a block of DMA data and a pointer to the next descriptor in the chain. The end of the chain is indicated when the pointer is zero.

### BRIEF DESCRIPTION OF THE DRAWINGS

The various embodiments of the present invention are illustrated by way of example, and not by way of limitation, in the figures of the accompanying drawings and in which:

FIG. 1 is a block diagram illustrating a computer system, including multi-function direct memory access (DMA) core logic to support micro-commands defining operations to be performed on DMA data, in accordance with one embodiment.

FIG. 2 is a block diagram further illustrating DMA logic of FIG. 1, in accordance with one embodiment.

FIG. 3 is a flowchart illustrating a method for processing DMA data associated with a DMA request according to an identified DMA micro-command, in accordance with one embodiment.

FIG. 4 is a flowchart illustrating a method for identifying a DMA micro-command associated with a DMA data request, in accordance with one embodiment.

FIG. 5 is a flowchart illustrating a method for processing received DMA data according to at least one identified DMA micro-command, in accordance with one embodiment.

FIG. 6 is a block diagram illustrating various design representations or formats for simulation, emulation and fabrication of a design using the disclosed techniques.

### DETAILED DESCRIPTION

A method and apparatus for a multi-function direct memory access core are described. In one embodiment, the method includes the reading of a direct memory access (DMA) descriptor having associated DMA data to identify at least one micro-command. Once the micro-command is identified, the DMA data is processed according to the micro-command during DMA transfer of the DMA data. In one embodiment, control logic directs processing on the DMA data in transit within a DMA engine according to the identified micro-command. Hence, by defining a primitive set of micro-commands, a DMA engine within, for example, an input/output (I/O) controller hub (ICH) or I/O processor, can be used to perform a large number of complex operations on the DMA data as the DMA data flows through the ICH without introducing latency into the DMA transfer.

In the following description, certain terminology is used to describe features of the invention. For example, the term “logic” is representative of hardware and/or software configured to perform one or more functions. For instance, examples of “hardware” include, but are not limited or restricted to, an integrated circuit, a finite state machine or even combinatorial logic. The integrated circuit may take the form of a processor such as a microprocessor, application specific integrated circuit, a digital signal processor, a micro-controller, or the like.

An example of “software” includes executable code in the form of an application, an applet, a routine or even a series of instructions. In one embodiment, an article of manufacture includes a machine or computer-readable medium having stored thereon instructions to program a computer (or other electronic devices) to perform a process according to one embodiment. The computer or machine readable medium includes, but is not limited to: a programmable electronic circuit, a semiconductor memory device inclusive of volatile memory (e.g., random access memory, etc.) and/or non-volatile memory (e.g., any type of read-only memory “ROM,” flash memory), a floppy diskette, an optical disk (e.g., compact disk or digital video disk “DVD”), a hard drive disk, tape, or the like.

System

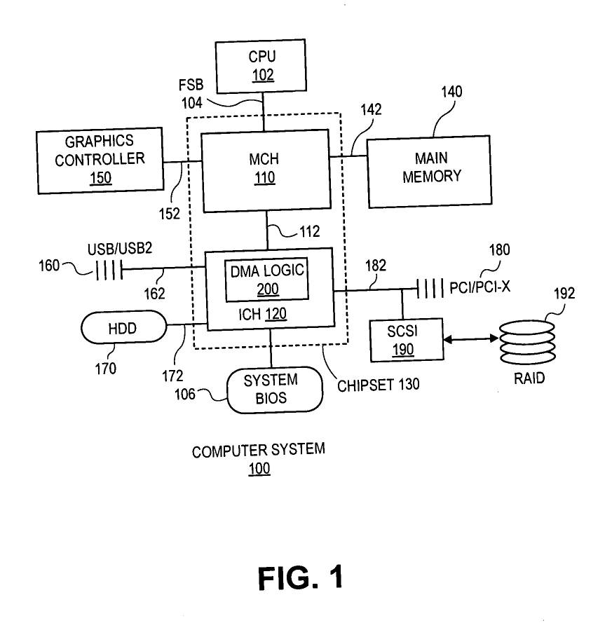

FIG. 1 is a block diagram illustrating computer system 100 including multi-function, direct memory access (DMA) core logic 200 to support multiple micro-commands defining operations to be performed on DMA data, in accordance with one embodiment. Representatively, computer system 100 comprises a processor system bus (front side bus (FSB)) 104 for communicating information between processor (CPU) 102 and chipset 130. As described herein, the term “chipset” is used in a manner to collectively describe the various devices coupled to CPU 102 to perform desired system functionality.

Representatively, chipset 130 may include memory controller hub 110 (MCH) coupled to graphics controller 150. In an alternative embodiment, graphics controller 150 is integrated into MCH, such that, in one embodiment, MCH 110 operates as an integrated graphics MCH (GMCH). Representatively, MCH 110 is also coupled to main memory 140 via memory bus 142. In one embodiment, main memory 140 may include, but is not limited to, random access memory (RAM), dynamic RAM (DRAM), static RAM (SRAM), synchronous DRAM (SDRAM), double data rate (DDR) SDRAM (DDR-SDRAM), Rambus DRAM (RDRAM) or any device capable of supporting high-speed buffering of data.

As further illustrated, chipset 130 includes an input/output (I/O) controller hub (ICH) 120. Representatively, ICH 120 may include a universal serial bus (USB) link or interconnect 162 to couple one or more USB slots 160 to ICH 120. Likewise, a serial advance technology attachment (SATA) 172 may couple hard disk drive devices (HDD) 170 to ICH 120. In addition, ICH 120 may include peripheral component interconnect (PCI)/PCI-X bus 182 to couple PCI slots 180 to ICH 120, such as small computer system interface (SCSI) 190 coupled to redundant array of independent disk (RAID) disk array 192. In one embodiment, system BIOS 106 initializes computer system 100.

Representatively, ICH 120 enables communication between the various peripheral devices coupled to ICH and chipset 130. As described herein, each device, or I/O card that resides on an I/O bus, such as USB bus 162 or PCI-X bus 182 are referred to herein as “bus agents.” Bus agents are generally divided into symmetric agents and priority agents, such that priority agents are awarded ownership when competing with symmetric agents for bus ownership. Such arbitration is required since bus agents are generally not allowed to simultaneously drive the bus to issue transactions.

As described herein, the term “transaction” is defined as bus activity related to a single bus access request. Generally, a transaction may begin with bus arbitration and the assertion of a signal to propagate a transaction address. A transaction, as defined by the Intel® architecture (IA) specification, may include several phases, each phase using a specific set of signals to communicate a particular type of information. Phases may include at least an arbitration phase (for bus ownership), a request phase, a response phase and a data transfer phase.

Within computer systems, such as computer system 100, memory access latency or the time required to write or read data from main memory 140 is often seen as a system bottleneck. Conventionally, main memory access by I/O devices is performed using programmed I/O transfers in which a CPU issues a bus transaction to either read or write data to/form memory for the I/O device. Accordingly, one technique for alleviating the memory bottleneck is DMA. DMA is a capability provided by advanced architectures which allows direct transmission of data from an attached device to main memory, without involving the CPU. As a result, the system's CPU is free from involvement with the data transfer, thus speeding up overall computer operation.

Implementing DMA access within a computer system, such as computer system 100, requires the designation of devices with DMA access as bus masters. A bus master is a program either in a microprocessor or in a separate I/O controller that directs traffic on the system bus or input/output (I/O) paths. For example, as depicted with reference to FIG. 1, SCSI 190 may be designated as a bus master to provide RAID 192 with DMA. In operation, bus master, such as SCSI 190 makes a request to the operating system (OS) for an assignment of a portion of main memory 140 which is designated or enabled for DMA.

The OS is responsible for designating a certain area of memory 140 as DMA enabled memory. Within the DMA enabled memory area, the OS will assign portions of this area to the various bus masters within the system 100. Once the assignment is received, the bus master is said to have established a DMA channel between the bus master and the main memory 140. As a result, during operation, when an I/O device such as RAID 192 requires read-write access to main memory 140, the bus master 190 performs a DMA access request to chipset 130.

To direct a controller, such as ICH 120, to perform DMA, an I/O device may populate the fields of a DMA descriptor. The fields of a DMA descriptor may include a source address, a destination address, a byte count to transfer and other attributes. In operation, the DMA descriptor is read by the controller, which either reads or writes requested data to or from memory, referred to herein as “DMA data.” A controller optimized to perform block transfers of data between an I/O device bus and main memory is referred to herein as a “DMA controller,” which are conventionally implemented within an I/O controller hub, such as ICH 120.

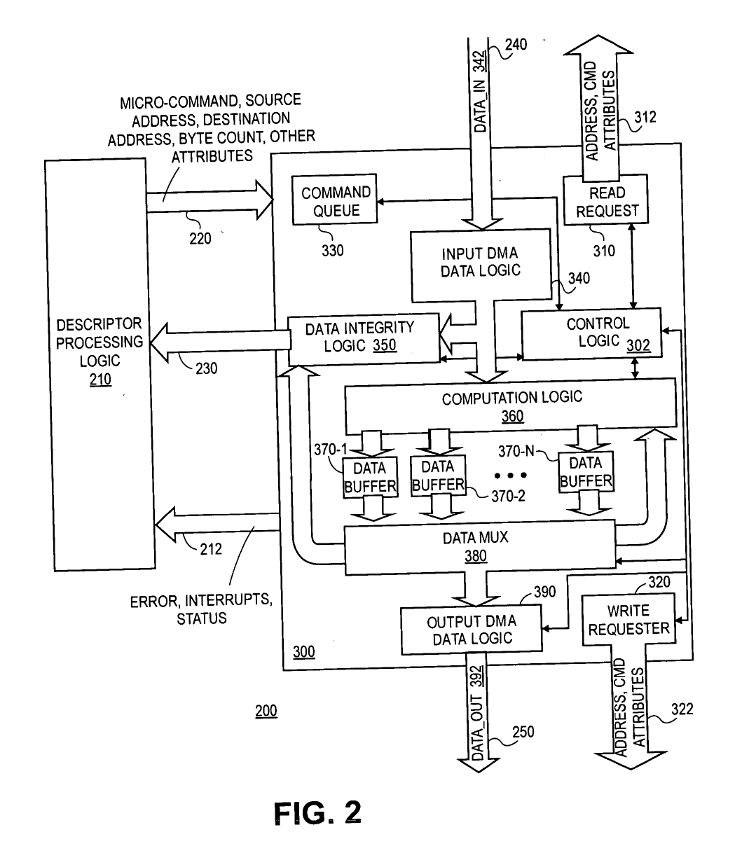

Conventional DMA controllers are generally limited to moving data from one memory, or I/O, location to another memory, or I/O, location. In contrast to conventional DMA controllers, ICH 120 includes DMA logic 200. In one embodiment, DMA logic 200 supports the use of DMA micro-commands selected by a bus master to direct DMA logic 200 to perform various functions. In one embodiment, DMA logic processes DMA data as the DMA data flows through DMA core 300 either to main memory 140 or from main memory 140, for example, as illustrated in FIG. 2.

As shown in FIG. 2, DMA logic 200 may include descriptor processing logic 210, which is coupled to DMA core 300. Representatively, descriptor processing logic 210 communicates with bus masters to process DMA descriptors populated by such bus masters. In one embodiment, such bus masters may populate a DMA descriptor by selecting parameters as well as one or more DMA micro-commands supported by DMA logic 200, for example, as illustrated in Table 1.

TABLE 1
DMA Commands

| | | |
|---|---|---|
| dma_cmd | I | Command |
| | | 0000 - DMA |
| | | 0001 - DMA with new seed |
| | | 0100 - buffer read |
| | | 0101 - buffer read with new seed |
| | | 0110 - buffer write |
| | | 0111 - block fill |
| | | 1000 - XOR FIRST |
| | | 1001 - XOR |
| | | 1010 - XOR LAST |
| | | 1011 - XOR ZERO CHECK |
| | | 1100 - XOR LAST RAID 6 |

Referring again to FIG. 2, in one embodiment, read requester 310 reads DMA data from main memory and write requester 320 writes DMA data to main memory, as directed by control logic 302. In one embodiment, control logic 302 processes all relevant DMA requests posted to a DMA buffer 370 in a round-robin fashion (it is possible to have other various buffer selection algorithms). In one embodiment, control logic 302 requires availability of a data buffer 370 (370-1, . . . , 370-N) to issue a read request. In other words, there is generally one pending read request per data buffer 370. Accordingly, DMA core 300 can effectively have up to NBUF (number of buffer) pending requests (in general, it is possible to have more than one read request per data buffer).

In one embodiment, descriptor logic 210 utilizes command interface 220 to store DMA micro-commands within command queue 330 of DMA core 300. Accordingly, as a DMA data request is received from a bus master, DMA data associated with the DMA data request is processed by DMA core 300 according to at least one associated DMA micro-command contained within command queue 330. In one embodiment, control logic 302 decodes DMA micro-commands associated with a received DMA data request to form one or more DMA micro-operations. In response to such decoded DMA micro-operations, control logic 302 directs the various components of DMA core 300 to perform various functions on the DMA data as DMA data flows through data buffers 370.

In one embodiment, the processing of DMA data associated with received DMA data request is performed under the direction of control logic 302. Accordingly, once identified DMA micro-commands are decoded into one or more DMA micro-operations, control logic 302 directs the various components of DMA core 300, as illustrated in FIG. 2 to process the DMA data. Representatively, control logic 302 may direct input DMA data logic 340 to process incoming DMA data by aligning the DMA data with reference to a DMA destination, as well as performing byte lane functions, such as swapping of incoming DMA data. In one embodiment, control logic 302 directs input DMA data logic 340 to perform cryptographic functions on the DMA data, such as encryption.

In one embodiment, control logic 302 directs input DMA data logic 340 to perform data alignment with reference to a destination for received DMA data, as well as byte lane swapping and encryption according to the decoded DMA micro-command. In one embodiment, DMA data logic 340 performs byte lane swapping of incoming data to support, for example, big endian processing. DMA data logic 340 also supports cryptographic functions, such as encryption of incoming DMA data to provide Galois Multiplication functionality using an encryption key specified by the encryption key (attribute field) provided with the DMA micro-command.

In one embodiment, control logic 302 may direct data integrity logic 350 to detect transmission errors of DMA data associated with received DMA data requests. In one embodiment, data integrity logic 350 enables the computation of a cyclic redundancy check (CRC), as well as checksum operations to detect data transmission errors of DMA data, which is corrupted during transmission. Likewise, control logic 302 may direct computational logic 360 to perform one or more DMA exclusive-OR (XOR) logical operations. In one embodiment, logic 360 includes an XOR engine to XOR incoming DMA data or transformed DMA data (using for instance, Galois multiplier) with data contained within the data buffer, as specified by a buffer ID (attribute) received with the associated micro-command.

In one embodiment, control logic 302 may direct output DMA data logic 390 to perform data alignment functionality for outbound DMA data. In one embodiment, output DMA data logic 390 to support swapping byte lanes in both incoming (input DMA data logic 304) and outgoing data paths to support big-endian applications. The endian byte swap can be performed according to the swap width (attribute field) provided with the micro-command. In one embodiment, control logic 302 decodes the following micro-commands to process DMA data in transit through DMA core 300 without actually copying data to another memory or I/O space:

dma—this micro-command can be used to perform a simple DMA operation. The DMA data is moved from a source address to a destination address. In one embodiment, CRC/Checksum/Encryption, etc., can also be computed for the DMA data by either input DMA logic 340 or data integrity logic 350.

dma_new_seed—this micro-command can be used to perform a simple DMA operation. The DMA data is moved from a source address to a destination address. In one embodiment, CRC register (contained in data integrity logic (350)) is loaded with the crc_seed provided with micro-command (attribute filed), before computing CRC for the DMA data by data integrity logic 350.

buf_rd—this micro-command is used to move DMA data from the source address to one of the internal buffers (370-1, . . . , 370-N). The DMA data is stored aligned to the destination address. CRC/Checksum/Encryption, etc., can also be computed.

buf_rd_new_seed—this micro-command can be used to move DMA data from the source address to one of the internal buffers (370-1, . . . , 370-N). The DMA data is stored aligned to the destination address. CRC register is loaded with the new seed provided with the micro-command (attribute field), before computing CRC for the DMA data.

XOR—this micro-command can be used to read data from the source address and exclusive-OR (XOR) to the data in a buffer specified by the src_buf_id (attribute field) provided with the command, and store the XORed data in the data buffer specified by the dest_buf_id (attribute field) provided with the command. The XORed data may be stored in the same buffer. CRC/Checksum/Encryption, etc., can be computed for incoming data. In addition, control logic 302 verifies that data buffer is all-zero for the specified byte count.

In one embodiment, XOR commands are broken up into multiple specific XOR commands. All XOR sequences require the same destination address except for XOR LAST RAID 6 command.

XOR FIRST—this command is used to read DMA data from the source address and aligned to the destination address as the DMA data is written into the data buffer 370. The XOR FIRST implies a start of an XOR sequence. All XOR sequences start with the XOR FIRST command. The DMA data is written in the data buffer specified by the dest_buf_id (attribute field) provided with the command. CRC/Checksum/Encryption, etc., can also be computed.

XOR LAST—this command is used to read DMA data from the source address and aligned to the destination address as the data is written into the data buffer. The XOR LAST command is used at the end of an XOR sequence. The DMA data is read from a buffer specified by the src_buf_id (attribute field) provided with the command from previous XOR or XOR FIRST command and bit-wise XOR with the new read data and written back to the data buffer specified by the dest_buf_id (attribute field) provided with the command. Once in the specified data buffer, the data can be written back out using the buffer write command. CRC/Checksum/Encryption, etc., can also be computed.

XOR ZERO CHECK—this command is identical to the XOR LAST command except that it performs a zero check on the resulting data. This is reported onto the zero_chk_fail signal along with dma_done. When the zero check fails, the zero_chk_fail signal is set.

XOR LAST RAID 6—this command is identical to the XOR LAST command except that this is an additional XOR command after the XOR LAST command. This calculates the diagonal parity. The destination address here is not required to be identical to the destination address of subsequent XOR commands. CRC/Checksum/Encryption, etc., can also be computed.

buf_wr—this micro-command can be used to write the data buffer specified by the dest_buf_id field provided with the micro-command to the destination address. No alignment operations are performed. It is assumed that the data in that buffer is already aligned to that destination address. CRC/Checksum/Encryption, etc., can be computed for outgoing data.

block_fill—this micro-command can be used to fill a block in the memory specified by the destination address with the fill data provided together with the micro-command.

Hence, control logic 302, in one embodiment, decodes a received DMA micro-command to perform the following commands for DMA data received from input port 240: DMA, DMA with new seed, buffer read, buffer read with new seed, XOR first, XOR, XOR last, XOR zero check and XOR LAST RAID 6. In one embodiment, control logic directs write port 250 perform, such as buffer_wr and block_fill micro-commands from command queue. A command interface for DMA core 300 is shown in Table 2.

TABLE 2
Command Interface

| | | |
|---|---|---|
| src_addr | I | Source address (read address) |
| dest_addr | I | Destination address (write address) |
| byte_count | I | Byte count (max 1 Byte) |
| log_in | I | Used for logging errors/completions |
| endian_swap | I | Perform endian swapping during data transfer. |
| | | Endian swapping is performed in 4 Byte aligned |
| | | chunks. |
| ab4s | I | Align before swap, If set data is aligned to the des- |
| | | tination before performing optional endian swap- |
| | | ping on data. Otherwise, data is aligned to the |
| | | destination address after performing optional endian |
| | | swapping. |
| fill_data | I | Data for block fill operation |
| crc_seed | I | Seed for computing CRC |
| buf_id_in | I | Buffer ID |
| | | This 2 bit encoded field identifies which buffer to |
| | | use for the data movement. |
| | | 00 - represents buffer 0, 01 - represents buffer 1, |
| | | 10 - represents buffer 2 and 11 - represents buffer 3. |
| dma_cmd | I | Command |
| | | 0000 - DMA |
| | | 0001 - DMA with new seed |
| | | 0100 - buffer read |
| | | 0101 - buffer read with new seed |
| | | 0110 - buffer write |
| | | 0111 - block fill |
| | | 1000 - XOR FIRST |
| | | 1001 - XOR |
| | | 1010 - XOR LAST |
| | | 1011 - XOR ZERO CHECK |
| | | 1100 - XOR LAST RAID 6 |
| valid_req | I | Valid DMA request |
| adg_en | I | Advance data guard enable |
| adg_mult | I | Advance data guard multiplier |
| crc_value | O | Computed CRC value |
| zero_chk_fail | O | Zero check results 1 - fail, 0 - pass |
| log_out | O | Output log information |
| buf_id_out | O | Buffer ID of the completed operation |
| buf_status | O | Data buffer status, 0 - idle, 1 - busy |
| dma_done | O | Indicate the completion of the DMA |

Although Table 2 lists a limited set of micro-commands, it is possible to add new micro-operations to enhance the features supported by DMA core 300. Procedural methods for implementing one or more of the above-described embodiments are now provided.

Operation

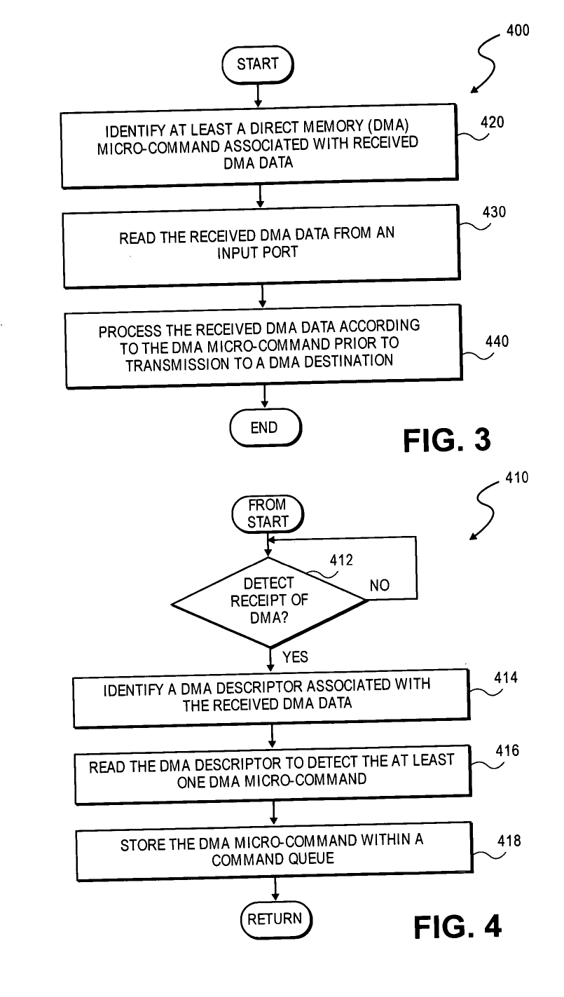

FIG. 3 is a flowchart illustrating a method 400 for processing DMA data associated with a DMA data request according to at least one identified micro-command associated with the DMA data, in accordance with one embodiment. At process block 420, a DMA micro-command associated with a received DMA data request, as defined by a DMA descriptor, is identified. Once identified, at process block 430, the DMA data may be read from an input port of, for example, a DMA engine. At process block 440, DMA data associated with the received DMA data request is processed according to the DMA micro-command prior to transmission to a DMA destination, as defined by the DMA descriptor associated with the DMA request.

FIG. 4 is a flowchart illustrating a method 410 performed prior to identifying of the DMA micro-command of process block 420 of FIG. 3, in accordance with one embodiment. At process block 412, it is determined whether receipt of a DMA data request is detected. Once detected, at process block 414, a DMA descriptor associated with the received DMA data request is identified. Once the DMA descriptor is identified, at process block 416, the DMA descriptor is read to detect the at least one micro-command associated with the received DMA data request. Subsequently, at process block 418, the DMA micro-command is stored within a command queue. In one embodiment, the above functionality described with reference to FIG. 4 is performed by, for example, descriptor processing 210, as shown in FIG. 2.

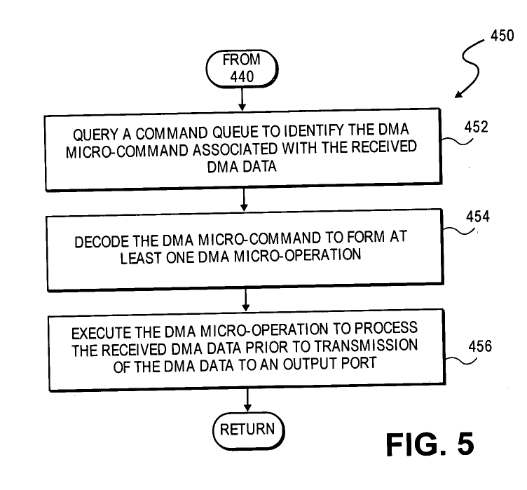

FIG. 5 is a flowchart illustrating a method 450 for processing DMA data associated with a received DMA data request of process block 440 of FIG. 3, in accordance with one embodiment. At process block 452, a command queue is queried to identify the DMA micro-command associated with the received DMA data request. At process block 454, the DMA micro-command is decoded to form at least one DMA micro-operation. Subsequently, at process block 456, the DMA micro-operation is executed to process DMA data associated with the DMA request prior to transmission of the DMA data to an output port.

Accordingly, in one embodiment, a DMA core, as illustrated in FIG. 2, is provided that supports micro-commands to provide flexibility and reusability for systems which require DMA access. In one embodiment, DMA logic 200 can be used to perform various complex operations by issuing a sequence of micro-commands. As indicated above, the sequence of micro-commands is selected by a bus master, which issues a DMA data request by listing the sequence of micro-commands within a DMA descriptor associated with the DMA data request. In one embodiment, DMA logic 200 supports the implementation of any new DMA descriptor format by simply altering descriptor processing logic 210, thereby significantly reducing time to market of new products. Accordingly, DMA logic 200 provides a new and efficient methodology for implementing reusable DMA cores by providing DMA core 300 that performs various functions on DMA data streams according to bus master selected DMA micro-commands.

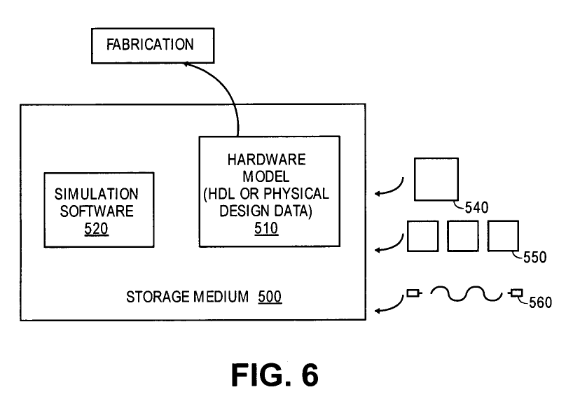

FIG. 6 is a block diagram illustrating various representations or formats for simulation, emulation and fabrication of a design using the disclosed techniques. Data representing a design may represent the design in a number of manners. First, as is useful in simulations, the hardware may be represented using a hardware description language, or another functional description language, which essentially provides a computerized model of how the designed hardware is expected to perform. The hardware model 510 may be stored in a storage medium 500, such as a computer memory, so that the model may be simulated using simulation software 520 that applies a particular test suite 530 to the hardware model to determine if it indeed functions as intended. In some embodiments, the simulation software is not recorded, captured or contained in the medium.

In any representation of the design, the data may be stored in any form of a machine readable medium. An optical or electrical wave 560 modulated or otherwise generated to transport such information, a memory 550 or a magnetic or optical storage 540, such as a disk, may be the machine readable medium. Any of these mediums may carry the design information. The term “carry” (e.g., a machine readable medium carrying information) thus covers information stored on a storage device or information encoded or modulated into or onto a carrier wave. The set of bits describing the design or a particular of the design are (when embodied in a machine readable medium, such as a carrier or storage medium) an article that may be sealed in and out of itself, or used by others for further design or fabrication.

### Alternate Embodiments

It will be appreciated that, for other embodiments, a different system configuration may be used. For example, while the system 100 includes a single CPU 102, for other embodiments, a multiprocessor system (where one or more processors may be similar in configuration and operation to the CPU 102 described above) may benefit from the multi-function DMA core of various embodiments. Further different type of system or different type of computer system such as, for example, a server, a workstation, a desktop computer system, a gaming system, an embedded computer system, a blade server, etc., may be used for other embodiments.

Having disclosed embodiments and the best mode, modifications and variations may be made to the disclosed embodiments while remaining within the scope of the embodiments of the invention as defined by the following claims.

1. A method comprising:
identifying at least one direct memory access (DMA) micro-command associated with a received DMA data request; and
processing received DMA data associated with the received DMA data request according to the DMA micro-command prior to transmission to a DMA destination.

2. The method of claim 1, wherein prior to identifying the DMA micro-command, the method comprises:
detecting receipt of a DMA data request;
identifying a DMA descriptor associated with the DMA data request;
reading the DMA descriptor to detect the at least one DMA micro-command; and
storing the DMA micro-command within a command queue.

3. The method of claim 1, wherein processing the DMA data further comprises:
querying a command queue to identify the DMA micro-command associated with the received DMA data request;
decoding the DMA micro-command to form at least one DMA micro-operation; and
executing the DMA micro-operation to process the DMA data prior to transmission of the DMA data to an output port.

4. The method of claim 1, wherein processing further comprises:
reading the DMA data from an input port;
computing an integrity check value as the DMA data is read from the input port; and
transmitting the DMA data to a DMA destination.

5. The method of claim 4, wherein computing the integrity check value comprises:
computing a cyclic redundancy check as the DMA data is stored within an available buffer; and
storing the DMA data within an available buffer aligned with reference to a DMA destination.

6. A method comprising:
decoding a direct memory access (DMA) micro-command associated with a received DMA data request to form at least one DMA micro-operation;
reading DMA data associated with the received DMA data request from an input port; and
processing the DMA data according to the DMA micro-operation prior to transmission of the DMA data to a DMA destination.

7. The method of claim 7, wherein decoding further comprises:
detecting the DMA data from a source address; and
querying a command queue to identify the DMA micro-command associated with the DMA data.

8. The method of claim 6, wherein processing the DMA data comprises:
computing a cyclic redundancy check as the DMA data is read from the input port; and
storing the DMA data within an available buffer aligned with reference to a DMA destination.

9. The method of claim 6, further comprising:
receiving a read completion indicator; and
swapping byte lanes of the DMA data as the DMA data is moved to a DMA destination.

10. The method of claim 6, wherein processing further comprises:
selecting data stored within an identified buffer; and
computing an exclusive OR operation (XOR) as the received DMA data is read from the input port with the selected data.

11. An apparatus, comprising:
a controller to receive at least one micro-command associated with a direct memory access (DMA) request; and
control logic to process, prior to DMA transfer of DMA data corresponding to the DMA request, the DMA data according to the at least one micro-command.

12. The apparatus of claim 11, wherein the controller further comprises:
descriptor processing logic coupled to the control logic to identify a DMA descriptor associated with DMA data request and to store at least one DMA micro-command identified within the DMA descriptor within a command queue.

13. The apparatus of claim 11, wherein the controller further comprises:
a command queue coupled to the control logic to store DMA micro-commands associated with DMA requests; and
data integrity logic coupled to the control logic to compute a cyclic redundancy check as DMA data is read from an input port and stored within an available buffer.

14. The apparatus of claim 13, wherein the controller further comprises:
data alignment logic coupled to the control logic to store DMA data within an available buffer aligned with reference to a DMA destination of the DMA data.

15. The apparatus of claim 13, wherein the controller further comprises:
an exclusive OR (XOR) engine coupled to the control logic to select data stored within an identified buffer and to compute an XOR operation of the selected data and DMA data as the DMA data is read from an input port.

16. The apparatus of claim 11, wherein the controller further comprises:
output DMA data logic to receive a read completion indicator and to swap byte lanes of DMA data as the DMA data is moved to a DMA destination.

17. The apparatus of claim 11, wherein the controller further comprises:
input DMA data logic to read DMA data from an input port and to encrypt the DMA data prior to transmission to a DMA destination.

18. The apparatus of claim 11, wherein the controller further comprises:
read port logic to issue a read request according to DMA read requests issued by one or more peripheral devices; and
write port logic to issue a write request according to DMA write requests issued by one or more peripheral devices.

19. The apparatus of claim 11, wherein the controller comprises an I/O controller.

20. The apparatus of claim 11, wherein the controller comprises an I/O processor.

21. A system comprising:
a processor;
a memory; and
a chipset coupled between the processor and the memory, the chipset comprising an input/output (I/O) controller hub including:
a command queue to store direct memory access (DMA) micro-commands associated with DMA data requests;
descriptor processing logic to identify a DMA descriptor associated with a DMA data request and to store at least one DMA micro-command identified within the DMA descriptor within the command queue, and
control logic to read at least one DMA micro-command associated with a DMA request from the command queue and to process, prior to a DMA transfer of DMA data corresponding to the DMA data request, the DMA data according to the at least one micro-command.

22. The system of claim 21, further comprising:
a peripheral device coupled to the chipset, the peripheral device to select at least one micro-command for associated DMA data and to issue a DMA data request to transfer of the DMA data associated with the DMA data request, the DMA data to be processed during DMA transfer according to the selected micro-command.

23. The system of claim 21, wherein the chipset comprises an input/output (I/O) controller hub (ICH).

24. The system of claim 21, wherein the chipset comprises an input/output (I/O) processor.

25. The system of claim 21, wherein the memory comprises a DDR SDRAM.

26. The system of claim 21, wherein the chipset comprises:
a DMA engine to transfer DMA data from a source address to a destination address according to a DMA descriptor associated with the DMA data.
